(19) United States
(12) Patent Application Publication
(10) Pub. No.: US 2026/0303886 A1
(43) Pub. Date: Oct. 1, 2026

(54) SYSTEMS AND METHODS FOR DELIVERING SUPPLEMENTAL CONTENT OVER MEDIA OVER QUIC TRANSPORT

(71) Applicant: Adeia Guides Inc., San Jose, CA (US)

(72) Inventor: Serhad Doken, Bryn Mawr, PA (US)

(21) Appl. No.: 19/093,777

(22) Filed: Mar. 28, 2025

(51) Int. Cl. H04N 21/237; H04N 21/643

(52) U.S. Cl. CPC H04N 21/237; H04N 21/643

(57) ABSTRACT

Systems and methods for transmitting supplemental content via an MoQ relay device are described herein. The MoQ relay device establishes a bi-directional connection with each of a publisher, a supplemental content server, and a client device. The MoQ relay receives a media stream via the bi-directional connection with the publisher, the media stream including a plurality of groups made up of objects. The MoQ relay then determines that an initial object of a particular group within the media stream corresponds to an insertion point for supplemental content and sends a request for supplemental content to the supplemental content server via the bi-directional connection. The MoQ relay subsequently receives the supplemental content and transmits the supplemental content to the client device via the bi-directional connection in place of the group corresponding to the insertion point.

### BACKGROUND

The present disclosure is related to systems and methods for transmitting supplemental content over the Media over QUIC (MoQ) transport solution.

### SUMMARY

QUIC (e.g., a UDP-Based Multiplexed and Secure Transport) is a general-purpose transport layer network protocol designed to enhance internet data transfer by addressing limitations inherent in traditional network protocols like Transmission Control Protocol (TCP). Operating over User Datagram Protocol (UDP), QUIC streamlines connection times by supporting operations based on a two-way handshake, supporting multiplexed connections without head-of-line blocking, and integrating encryption directly into the protocol. Collectively, these features contribute to QUIC providing more secure, more robust, and lower latency data transfer connections than other network protocols.

Media over QUIC (MoQ) transport is a QUIC-based solution that brings the advantages of QUIC for use by streaming, gaming, and real-time conferencing computer systems. In some embodiments, MoQ is laid on top of QUIC mechanisms (QUIC streams and/or QUIC datagrams) and may be used over raw QUIC or Web Transport. Media sent and received using the protocol can also be encrypted at the transport layer using standard QUIC and may be end-to-end encrypted. MoQ includes a single protocol for sending and receiving high-quality media (including audio, video, and time metadata such as closed captions and cue points) in a way that provides ultra-low latency for the end user device.

One aspect of MoQ is its configuration as a publisher/subscriber protocol utilizing a relayed media distribution architecture. In this architecture, publisher devices generate and transmit media content while subscriber devices express interest in specific media streams and receive the corresponding streaming data from the publisher via a distribution chain of one or more relay devices. Relays are another component of MoQ's distribution architecture. Relays act as intermediaries between the publisher and subscribers by caching received media streams and forwarding them downstream to other relays and/or client devices. By strategically placing relays throughout a distribution network (e.g., within content delivery networks (CDNs), 5G infrastructures, and even local Wi-Fi networks), MoQ reduces the distance data must travel to reach subscribers, effectively reducing latency and improving scalability. Since data can be transferred from one relay to multiple relays and then forwarded to multiple client devices, MoQ enables a fan-out distribution system where a single copy of media can simultaneously be distributed to numerous client devices. Furthermore, the publisher/subscriber protocol supports multiple media formats, interoperability when indicating the media and media format being sent, rate adaptation strategies based on changing codec rates or chosen media encoding/qualities, and cache-friendly mechanisms.

There is still a need for a solution to efficiently and reliably provide supplemental content (e.g., weather alerts, breaking news, emergency alerts, sports scores, advertisements, etc.) over MoQ. In some approaches for TCP-based streaming protocols such as HTTP Live Streaming (HLS) or Dynamic Adaptive Streaming over HTTP (DASH), supplemental content is transmitted to a viewer device based on a request from the respective user device. When the user device initiates streaming content, the video player communicates with a server to request supplemental content. The supplemental content server then selects appropriate supplemental content based on viewer data and sends them to the video player, which inserts them into the content stream. This scheme allows for real-time targeting and personalization, as supplemental content can be tailored to individual viewer characteristics such as demographics, location, and browsing history. However, this approach is particularly susceptible to supplemental content blockers and is difficult to scale since every supplemental content request needs to be addressed individually. A server handling a surge of supplemental content requests could easily become overloaded, particularly within MoQ's media distribution architecture, which is designed to deliver multiple copies of media content efficiently rather than managing numerous individualized streams.

In some HLS and DASH approaches, a server stitches uniform resource identifiers (URIs) for retrieving supplemental content together with URIs for retrieving primary content to create a single manifest file. When the server receives a request from a user device to view the primary content, the server transmits the single manifest file with the pre-stitched supplemental content URIs. This method enables a viewing experience with limited buffering or latency issues, as the video player continuously fetches content from the same manifest file without being required to spend additional time and/or processing power to request supplemental content.

Nonetheless, despite its effectiveness, this approach comes with notable drawbacks. One significant limitation is the substantial processing power required to handle insertion of supplemental content during large-scale events, such as live sports broadcasts, where stitched manifests need to be generated and delivered to all user devices. This demand creates peaks of centralized processing power, which can strain infrastructure resources. Furthermore, the size of manifests can also become an issue at scale when client devices are constantly polling for updated manifests, resulting in a concurrency challenge due to the highly cacheable responses that are generated. Similarly, after these peak moments, the supplemental content insertion servers may remain idle, resulting in inefficient resource allocation. Lastly, since the manifest for supplemental content is stitched with the primary manifest at the server, this approach limits options for personalization, tracking and measurement, and support for new content formats, since every client device requests the same supplemental content from the server.

In some approaches, instead of stitching the URIs for the main content and supplemental content together at the server, the server provides a pod (e.g., a metadata structure) identifying manifest URIs for supplemental content suitable for a particular client device. The main content may be marked with resolution points that indicate insertion opportunities for supplemental content. A client video player application may request and receive supplemental content when it detects a resolution point and then stitches the main content and supplemental content together at the client device, instead of at the server as described in the approach above. The supplemental content insertion is still controlled by the content provider's service, therefore enabling precise targeting based on user-specific information while minimizing the impact on network bandwidth and server recourses. Nonetheless, while this approach works with HLS and DASH, it is not optimized to operate with MoQ. For example, this approach still requires each client device to send a request for a supplemental content pod to a supplemental content server. This can cause unwanted latency for MoQ's fan-out approach, where a relay is configured to efficiently distribute a single copy of media content to several subscribers without the need for any additional feedback from the subscribers themselves. Furthermore, all current solutions for HLS and DASH are stateless (or sessionless) in nature, whereas MoQ is stateful (sessionful). In a stateful system, the server maintains session information and context between interactions, enabling more efficient and personalized communication, while stateless systems treat each request as an isolated transaction without any retained context. As stateless protocols, HLS and DASH are equipped to deliver content segments as they are requested from a client device referencing a manifest file without maintaining a continuous “session” between the client device and server. A consistent connection, therefore, does not need to be maintained since each content segment request is independent from the other. While stateless protocols are easy to deploy, they also face latency limitations and inefficiencies since each segment must be requested and delivered individually. MoQ on the other hand, as a stateful protocol, maintains a persistent session between the client and the server. This enables MoQ to transmit information over multiple streams (thus avoiding head-of-line blocking) and to use session data for effective congestion control and error recovery. Together, these features result in a lower latency and a more resilient connection between the server and the client device. Therefore, there is a need for a supplemental content delivery solution that leverages an MoQ-based media distribution architecture without causing unwanted latency or scaling issues.

To solve these problems, systems, and methods, are disclosed herein for establishing, by a Media over QUIC (MoQ) relay device, a bi-directional connection between the MoQ relay device and a client device for transmitting a media stream including groups corresponding to supplemental content insertion points to the client device. In particular, based at least in part on receiving a request to subscribe to a media stream from the client device, the MoQ relay device establishes a bi-directional connection between the MoQ relay device and a publisher of the media stream. The MoQ relay device then receives the media stream from the publisher to be transmitted to the client device via the bi-directional connection between the MoQ relay device and the client device. The media stream comprises a plurality of groups, each group including a plurality of objects. As the MoQ relay device receives the media stream, it determines that an initial object of a particular group of the plurality of groups corresponds to a supplemental content insertion point and transmits a request to a supplemental content server to provide supplemental content via the bi-directional connection between the MoQ relay device and the supplemental content server. The MoQ then receives the supplemental content item via the bi-directional connection between the MoQ relay device and the supplemental content server, prevents transmission of at least the particular group of the plurality of groups to the client device via the bi-directional connection between the MoQ relay device and the client device, and transmits the supplemental content item in place of at least the particular group of the plurality of groups to the client device via the bi-directional connection between the MoQ relay device and the client device.

In some embodiments, the client device is one of a plurality of client devices, and the MoQ relay device establishes a bi-directional connection between the MoQ relay device and each of the plurality of client devices. Therefore, the MoQ relay device transmits the media stream and the supplemental content item to each of the plurality of client devices. In such embodiments, the request from the MoQ relay device to the supplemental content server includes at least one of preference information corresponding to the plurality of client devices, metadata related to the media stream, or a length of the supplemental content insertion point.

These aspects help overcome issues regarding latency, scalability, and personalization discussed in the approaches above. Since this solution utilizes MoQ, it can take advantage of the benefits of transmitting content via stateful connection. An MoQ server can therefore leverage just-in-time decisioning while still maintaining a low-latency and robust streaming connection with client devices. Furthermore, by transmitting both content and supplemental content from a single MoQ relay device to multiple client devices (e.g., via a fan-out architecture), the media distribution architecture can be scaled easily by adding additional MoQ relay devices to connect client devices to a provider. Unlike some other approaches, the MoQ relay device receives data that does not yet have supplemental content stitched in (e.g., pre-stitched manifests). This approach enables the system to deliver personalized supplemental content to its subscribed client devices based on their unique preferences, while maintaining overall scalability. For example, each MoQ relay device within the media distribution architecture may request and receive supplemental content based on user and/or profile information received from the subscribed client devices. This solution, therefore, avoids the deficiencies of previous strategies, such as broadcasting identical supplemental content to all devices or processing individual content requests from each subscriber separately. Additionally, by shifting content coordination from the publisher to an MoQ relay device, the system distributes processing more evenly throughout the media distribution architecture instead of consolidating tasks (such as content stitching at the publisher or supplemental content delivery at a dedicated server), thereby enhancing resilience to peaks in needs for delivering supplemental content. Furthermore, client devices can communicate with an MoQ relay device that is potentially much closer than the publisher, contributing to a lower-latency supplemental content delivery.

In some embodiments, the MoQ relay device receives a data structure identifying the supplemental content. The MoQ relay device may use information from the data structure to request and receive the supplemental content (e.g., from a supplemental content server). These aspects enable the system to leverage the pod-serving approach described above, although in this configuration the data structure (e.g., a pod) is received by the MoQ relay device instead of a client device. This arrangement maintains low latency for the supplemental content stream to each client device and reduces processing demands, as it eliminates the need for each client device to receive an individual data structure for identifying supplemental content.

In some approaches, the MoQ relay device receives the data structure identifying the supplemental content item based at least in part on the supplemental content server receiving a plurality of offers from a plurality of supplemental content providers to select their supplemental content. In some approaches, receiving the data structure is based at least in part on the MoQ relay device receiving a plurality of offers from a plurality of supplemental content providers to select their supplemental content. In such approaches, the supplemental content item received at the MoQ device corresponds to a supplemental content provider with an accepted offer.

In some embodiments, the request to the supplemental content server to provide the supplemental content is a first request. In such embodiments, the MoQ relay device may determine that an initial object of a second group of the plurality of groups corresponds to an additional supplemental content insertion point. The MoQ relay device then transmits a second request to the supplemental content server to provide supplemental content via the bi-directional connection between the MoQ relay device and the supplemental content server. In some embodiments, the MoQ relay device receives an indication that no suitable supplemental content item was identified by the supplemental content server and transmits the second group of the plurality of groups to the client device. Such aspects enable the system to be equipped with situations where it does not receive supplemental content for the insertion point, by transmitting the second group of the plurality of groups instead of a supplemental content. Since the MoQ relay device is not required to perform any additional steps to account for a lack of supplemental content, the MoQ relay device is able to maintain the low-latency stream.

In some embodiments, the MoQ relay device is at least one of a node of a content delivery network (CDN), a mesh network node, a wireless access point, an IoT gateway, or a cloud-based relay. Such aspects enable this system to be scaled up without requiring reliance solely on centralized CDN infrastructures, as the MoQ relay device performs content processing and supplemental delivery closer to the client devices, thereby reducing latency and distributing processing loads more evenly throughout the content delivery architecture.

In some approaches, the MoQ relay device is a first MoQ relay device. In such approaches, the MoQ relay device may establish a bi-directional connection with a second MoQ relay device which itself makes bi-directional connections with a second client device.

In some embodiments, a request to subscribe to the media stream from the second client device is received via the bi-directional connection between the MoQ relay device and a second MoQ relay device.

In some approaches, each object of the plurality of objects corresponds to at least one of a video frame or a group of pictures (GOP).

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1A depicts an illustrative example of establishing connections between user devices and a publishing server via an MoQ relay, in accordance with some embodiments of this disclosure;

FIG. 1B depicts an illustrative example for a publisher server transmitting an MoQ stream, including placeholder objects for supplemental content, to user devices via an MoQ relay, in accordance with some embodiments of this disclosure;

FIG. 1C depicts an illustrative example for an MoQ relay requesting supplemental content from a supplemental content server, in accordance with some embodiments of this disclosure;

FIG. 1D depicts an illustrative example for an MoQ relay receiving supplemental content, replacing placeholder objects of an MoQ stream with objects corresponding to the supplemental content, and transmitting the MoQ stream including the supplemental content to a user device, in accordance with some embodiments of this disclosure;

FIG. 1E depicts an illustrative example for an MoQ relay receiving an indication that no supplemental content is available and transmitting the MoQ stream including the placeholder objects, in accordance with some embodiments of this disclosure;

FIG. 2 depicts an illustrative example of a track of objects transported over an MoQ stream, in accordance with some embodiments of this disclosure;

FIG. 3 depicts an illustrative sequence diagram for establishing a fetching content via an MoQ stream, in accordance with some embodiments of this disclosure;

FIG. 4 depicts an illustrative example for an MoQ relay orchestrating a subscription switch, in accordance with some embodiments of this disclosure;

FIG. 5 shows illustrative devices and systems for causing simultaneous display of portions of a media asset, in accordance with some embodiments of this disclosure;

FIG. 6 shows illustrative devices and systems for causing simultaneous display of portions of a media asset, in accordance with some embodiments of this disclosure;

FIG. 7A depicts an illustrative request for fetching supplemental content, in accordance with some embodiments of this disclosure;

FIG. 7B depicts an illustrative fetch response for supplemental content, in accordance with some embodiments of this disclosure;

FIG. 7C depicts an illustrative message for inquiring about supplemental content availability, in accordance with some embodiments of this disclosure;

FIG. 7D depicts an illustrative confirmation message for available supplement content, in accordance with some embodiments of this disclosure;

FIG. 8 depicts is an illustrative flowchart for a process of an MoQ relay receiving and transmitting a media stream via bi-directional connections between a publishing server and client device, in accordance with some embodiments of this disclosure; and

FIG. 9 is an illustrative sequence diagram for the process of MoQ relays coordinating with publishers and supplemental content servers to provide supplemental content-embedded content to subscribers, in accordance with some embodiments of this disclosure.

### DETAILED DESCRIPTION

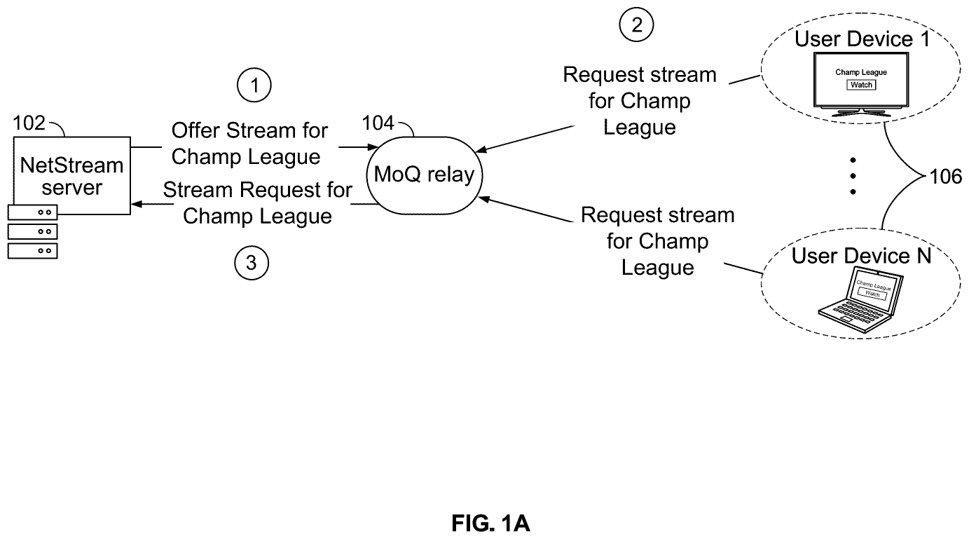

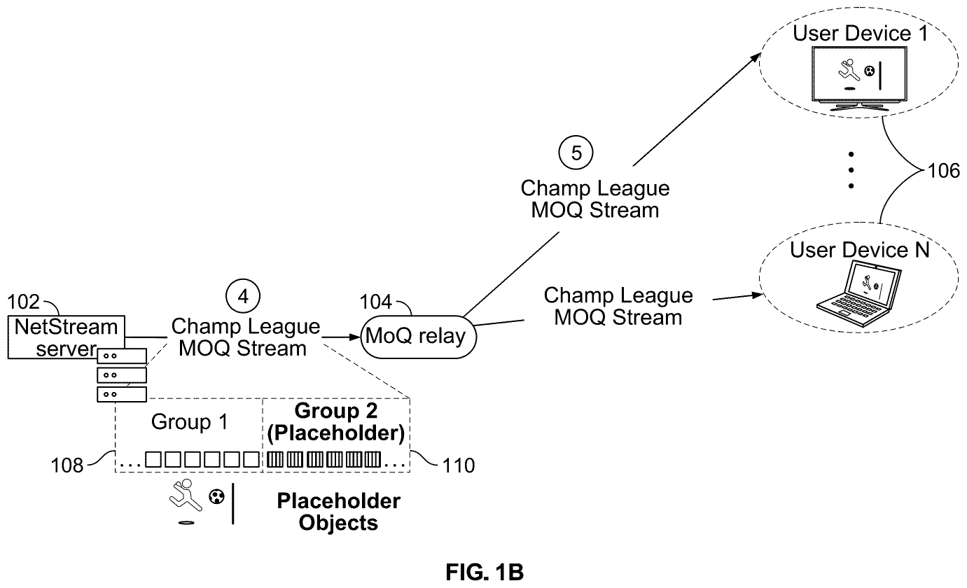

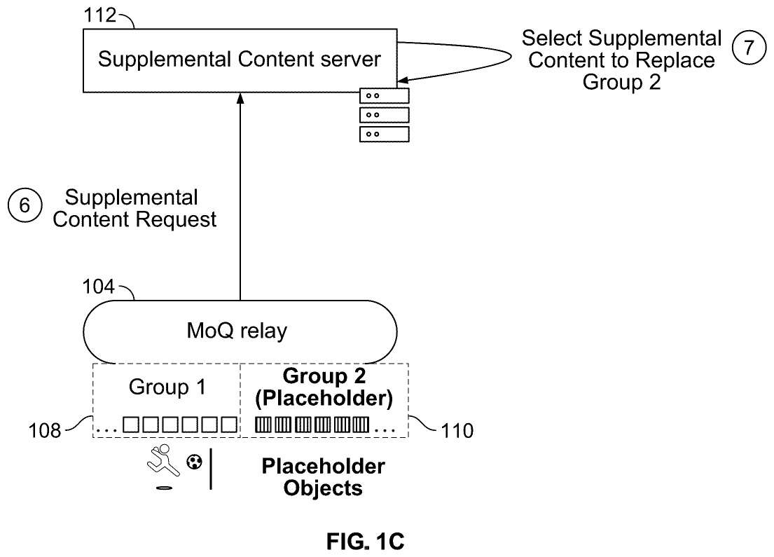

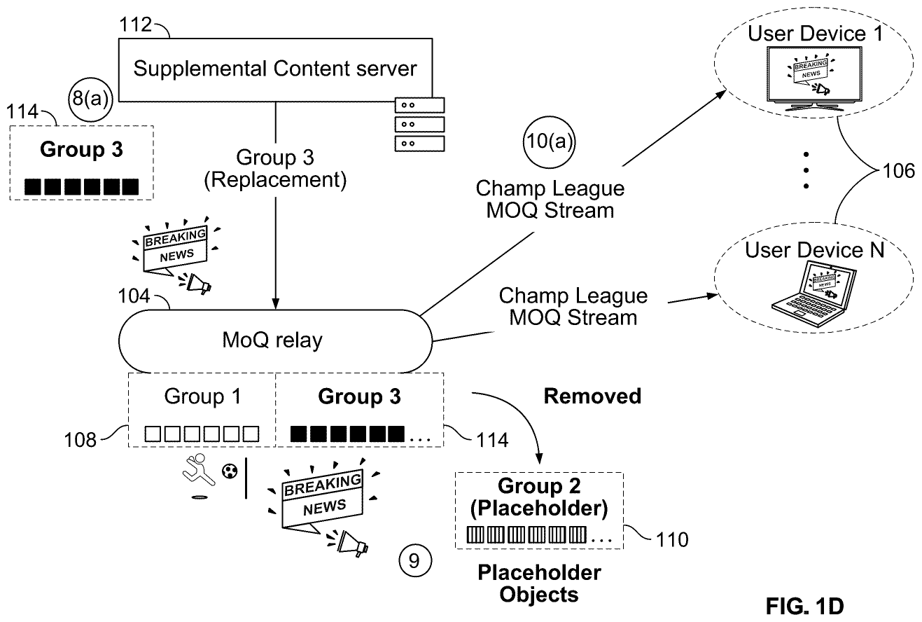

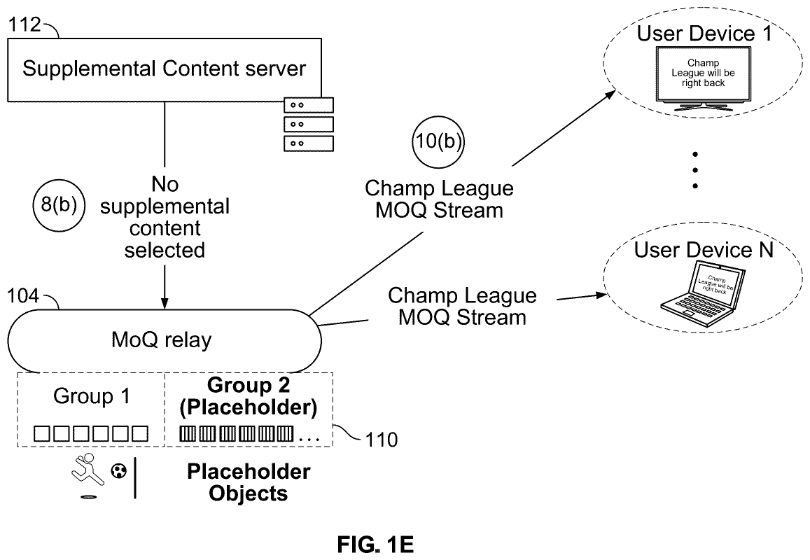

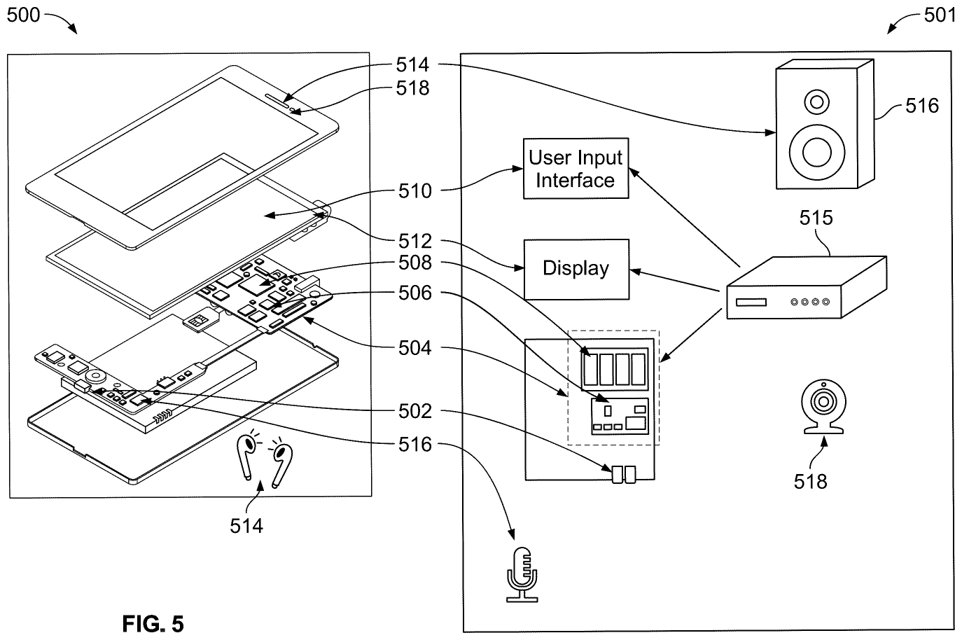

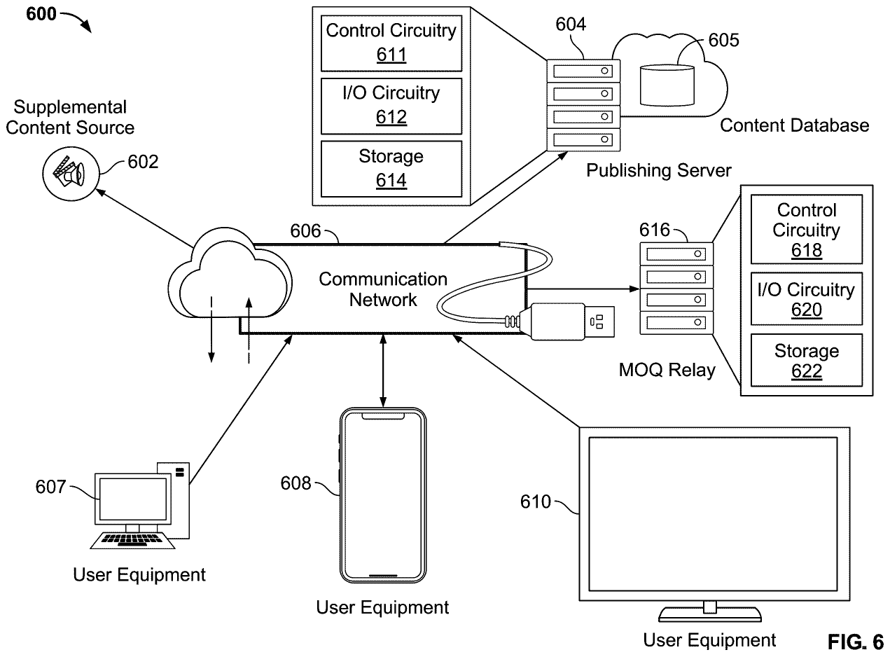

FIG. 1A depicts a streaming architecture for establishing connections between user devices 106 and e.g., NetStream server 102 (or any other suitable publisher) via MoQ relay 104, in accordance with some embodiments of this disclosure. The streaming architecture of FIG. 1A utilizes the MoQ transport protocol to establish connection between NetStream server 102 (e.g., corresponding to publishing server 604 of FIG. 6) and user devices 106 (e.g., corresponding to devices 500, 501 of FIG. 5 and/or computing devices 607, 608, 610 of FIG. 6), using MoQ relay 104 as an intermediary device (e.g., corresponding to MoQ relay 616 of FIG. 6). As referred to herein, the term “MoQ relay” may be understood to mean any intermediary device within an MoQ delivery network that facilitates the transmission, routing, and buffering of media content between origin servers and end-user devices. In some embodiments, MoQ relay 104 may be a content delivery network (CDN) server, 5G infrastructure node, Wi-Fi router, cellular base station, edge computing node, caching proxy, network switch, or any other suitable intermediary hardware or software solution designed to optimize data delivery. As referred to herein, “user device,” such as, for example, user devices 106, refers to any device capable of displaying the aforementioned media content such as a smartphone or tablet, a laptop computer, a personal computer, a desktop computer, a smart television, a smart watch or wearable device, a projector, a monitor, or any other media device, or any combination thereof.

In some embodiments, MoQ relay 104 is configured to receive (e.g., via input/output (I/O) circuitry 620 of FIG. 6), cache (e.g., via storage 622 of FIG. 6), and forward subscribable MoQ media streams from publishers to subscribers across wired, wireless, or hybrid network environments. In some embodiments, the streaming architecture for delivering MoQ streams includes multiple MoQ relays that feed other MoQ relays and that each have their own subscribers. In these embodiments, the MoQ relays may be grouped and/or layered across different regions, with each region containing a set of user devices that can connect to and retrieve cached data from the MoQ relay. In some approaches, this clustered MoQ layout (e.g., a fan-out distribution architecture) facilitates reduced latency data transmission by shortening the distance data must travel to each subscriber. For example, when each region has its own dedicated MoQ relay, content is cached at each MoQ relay, allowing user devices to retrieve data from their nearby MoQ relay rather than querying a distant publishing server. In some embodiments, content from a publishing server is transmitted to a first cluster of MoQ relays, which then distribute the content to additional clusters of MoQ relays, therefore expanding the reach of the streaming architecture. In some embodiments, when needed, additional MoQ relays can be integrated into the streaming architecture to serve regions without an MoQ relay, thereby enabling efficient scaling while maintaining low-latency data transfer to each user device.

In some embodiments, a publishing server transmits an MoQ message to MoQ relays to offer user devices to subscribe to its MoQ stream for media content. For example, as shown in step 1, NetStream server 102 may transmit an MoQ message to MoQ relay 104 offering user devices (e.g., including user devices 106) to subscribe to a stream for Champ League. In some embodiments, user devices 106 may subsequently receive a transmission of the subscription offer, e.g., based on user devices 106 accessing a web page or application related to NetStream content. In some embodiments, as shown in step 2, user devices 106 transmit (e.g., via I/O circuitry 502 of FIG. 5) a request (e.g., via a control message) to receive the stream for Champ League, e.g., based on each user device receiving a user input (e.g., via input interface 510) corresponding to the subscription offer. In some embodiments, user devices 106 automatically transmit the request for Champ League based on receiving the subscription offer. As shown in step 3, when MoQ relay 104 receives the request for the stream for Champ League from user devices 106 it forwards each of the requests to NetStream server 102, establishing a bi-directional publisher/subscriber (pub/sub) connection between NetStream server 102 and each of user devices 106 (i.e., only a two-way handshake is required to establish the connection between publishing server and subscriber due to the MoQ transport protocol being built on QUIC).

In some embodiments, the pub/sub connection enables each user device to receive media content via a real-time feed using the MoQ transport protocol. In some embodiments, rather than requiring each user device to request each individual chunk as in HLS and DASH, the publishing server continuously transmits the real-time feed to the MoQ relay. In such embodiments, unlike HLS and DASH, which transmit duplicate streams to each user, the MoQ relay receives a single stream and disperses the same stream to each user device via the pub/sub connection. In some approaches, the MoQ relay caches (e.g., at storage 622 of FIG. 6) the media content transported by MoQ stream such that each new user device can efficiently access the content from the MoQ relay instead of requesting the publishing server directly. In some approaches, this transmission configuration increases the streaming architecture's efficiency since it moves tasks such as content delivery orchestration and stream replication from the publishing server to the MoQ relay, thereby reducing redundant processing and lowering overall network load. Furthermore, in some embodiments, the MoQ transport protocol is configured to transmit data for individual frames (i.e., objects). In such embodiments, subscribed user devices can begin playing the media content received via the MoQ stream as soon as they receive the data corresponding to the first frame rather than waiting to download and decode a chunk before playing the content, as is required for HLS and DASH. In conjunction with MoQ's built-in flow control and loss recovery solutions, this transmission configuration enables the described streaming architecture to transport media content at low latency. In some embodiments, the streaming architecture is configured to transmit chunks over the pub/sub connection.

FIG. 1B depicts an illustrative example for NetStream server 102 (e.g., corresponding to publishing server 604) transmitting an MoQ stream, including a group of placeholder objects, to user devices 106 (e.g., corresponding to devices 500, 501 of FIG. 5 and/or computing devices 607, 608, 610 of FIG. 6) via MoQ relay 104 (e.g., corresponding to MoQ relay 616 of FIG. 6), in accordance with some embodiments of this disclosure. In some embodiments, when a publisher server (e.g., NetStream server 102) receives (e.g., via I/O circuitry 620 of FIG. 6) a subscription request for an MoQ stream from a user device, the publishing server first verifies (e.g., via control circuitry 618 of FIG. 6) whether the user device or an associated user profile is authorized to access the media content corresponding to the MoQ Stream. If authorization is confirmed, the publishing server transmits (e.g., via I/O circuitry 620 of FIG. 6) the media content (e.g., Champ League) as part of the MoQ stream to the connected MoQ relay. In some approaches, the publishing server begins transmitting the MoQ stream to the MoQ relay immediately upon receiving the subscription request without performing an authorization check. In some embodiments, the MoQ stream delivered to the user devices includes a confirmation message indicating the status of the subscription and/or access permissions.

As referred to herein, the terms “media content,” such as for example Champ League, may be understood to mean electronically consumable visual user content, such as television programming, as well as pay-per-view programs, on-demand programs (as in video-on-demand (VOD) systems), live content, Internet content (e.g., streaming content, downloadable content, webcasts, etc.), video clips, 3D-content, content information, pictures, GIFs, rotating images, documents, playlists, websites, articles, books, electronic books, blogs, advertisements, chat sessions, social media, applications, games, and/or any other visual media or multimedia and/or combination of the same.

Step 4 shows NetStream server 102 transmitting the MoQ stream for Champ League to MoQ Relay 104 for distribution to user devices 106. In some embodiments, the MoQ stream transmits the media content in the form of a track. In some approaches, a track is a sequence of groups, each group containing a set of objects. In these embodiments, each object represents the smallest addressable unit of data, such as a frame, a chunk, or another portion of the media content. In some approaches, the publishing server assigns metadata to the first object (or any other suitable object) of a group, e.g., to indicate the type of content, the length of the group, or any other suitable metadata. For example, NetStream server 102 assigns metadata for group 108 that identifies group 108 as Champ League content containing six objects and assigns metadata for placeholder group 110 indicating that it contains placeholder objects for six supplemental content objects that can be inserted into the MoQ stream at MoQ relay 104. In some embodiments, the content corresponding to placeholder group 110 may be a default weather, news, or traffic update, a “Will be right back” message, a generic promotional offer from the publisher, or any other suitable embodiment of placeholder content. As shown in step 5, when the MoQ stream for Champ League reaches MoQ relay 104, MoQ relay 104 distributes the MoQ stream to subscribed user devices 106. In some embodiments, MoQ relay 104 caches (e.g., at storage 622 of FIG. 6) the track for Champ League. This allows the relay to provide the cached media content to an additional user device that requests a subscription or to a user device that is already subscribed and requests to view an earlier portion of the media content.

FIG. 1C depicts an illustrative example for MoQ relay 104 (e.g., corresponding to MoQ relay 616 of FIG. 6) detecting a placeholder group within the received MoQ stream and requesting supplemental content from a supplemental content server (e.g., corresponding to supplemental content source 602 of FIG. 6), in accordance with some embodiments of this disclosure. As discussed in the description of FIG. 1B, in some embodiments, the publishing server (e.g., publishing server 604 of FIG. 6) assigns metadata to the first object of each group. For example, the metadata in the MoQ stream shows that group 108 contains objects for displaying Champ League while placeholder group 110 contains placeholder objects indicating an insertion opportunity for supplemental content. In some embodiments, when groups are received by an MoQ relay, the MoQ relay inspects the metadata of the first object of each group to determine what type of content is contained in each group, to determine whether to delay transmission of the group to the subscribed user devices, or to perform any other suitable operation related to the group's metadata. For example, when MoQ relay 104 receives group 108, MoQ relay determines that group 108 contains objects for displaying Champ League and subsequently distributes the respective frames to user devices 106. When MoQ relay 104 receives placeholder group 110 and determines that it corresponds to a placeholder for supplemental content, MoQ relay 104 records the length of the placeholder group (e.g., based on the number of objects or the time-length of the frames corresponding to the objects), delays the transmission of the group to user devices 106 and prepares a request for the supplemental content. In some embodiments, the MoQ relay uses a timer to determine the length of the supplemental content needed to replace the placeholder object.

As referred to herein, the term “supplemental content” may be understood to mean electronically consumable additional information and interactive features that enhance or complement primary media content, such as weather alerts, breaking news, emergency notifications, live sports scores, real-time traffic updates, advertisements, financial tickers, public service announcements, event reminders, social media notifications, interactive promotions, contextual pop-ups, digital signage, user notifications, and/or any other ancillary content or multimedia data provided to augment the user experience. In some embodiments, the supplemental content may be non-live or live content.

Step 6 demonstrates that in some embodiments, after identifying a placeholder object, MoQ relay 104 transmits a supplemental content request to supplemental content server 112. In some embodiments, this request includes user data (e.g., first party data) from one or more subscribed user devices and/or their associated user profiles, metadata about the media content delivered by the MoQ stream, the length of the supplemental content placeholder, and/or any other suitable information for fetching supplemental content, collectively referred to herein as “personalized supplemental content data.” Each user device may send their respective user data (e.g., via a control message) to the MoQ relay based on a specific request from the MoQ relay, based on the confirmation message described in relation to FIG. 1B, or at any other suitable trigger.

In some embodiments, the user data transmitted from each user device to the MoQ relay may be encrypted, e.g., to protect confidentiality and ensure compliance with applicable privacy standards, guidelines, regulations, or industry best practices. For example, in embodiments where the QUIC-based MoQ protocol is used, the system will have encryptions mechanisms such as Transport Layer Security (TLS) 1.3 built into the protocol. In some embodiments, the system may use any suitable encryption technique, including symmetric encryption algorithms (e.g., Advanced Encryption Standard (AES), Triple Data Encryption Standard (3DES)), asymmetric encryption algorithms (e.g., Rivest-Shamir-Adleman (RSA), Elliptic Curve Cryptography (ECC)), any combination thereof, or any other suitable encryption technique. Moreover, data may further undergo end-to-end encryption (E2EE), thereby ensuring that user data remains encrypted throughout the transmission process from the originating user device to the intended recipient.

At step 7, upon receiving the personalized supplemental content data, supplemental content server 112 initiates the supplemental content selection process. For example, supplemental content server 112 may send proposals to supplemental content providers such as weather services, news services, emergency services, sports media providers, advertisers, or any other qualified supplier, inviting them to supply supplemental content. In some embodiments, the content may be selected based on user preferences, geographic relevance, predefined selection criteria, or any other suitable criteria that enables the supplemental content server to select supplemental content relevant to one or more subscribers of the respective MoQ relay. For example, personalized supplemental content data may indicate that user devices 106 are located in the Los Angeles area, therefore causing supplemental content server 112 to select a Los Angeles-based weather alert to send back to MoQ relay 104. As another example, there may be a breaking news report of high importance in the area of an MoQ relay 104 that causes the supplemental content server 112 to select the news report as the supplemental content to send back to MoQ relay 104. As a final example, in embodiments where supplemental content is selected for each user device individually, the supplemental content server may determine that the user profile of a particular device indicates a user preference for a sports team and therefore selects a sports score update to be displayed at the particular user device.

In some embodiments, the supplemental content server selects the content through a real-time bidding process. In such embodiments, the supplemental content server evaluates offers submitted by supplemental content providers. Each offer may be assessed based comparing the offer to characteristics of the personalized supplemental content data and/or any other data received from the MoQ relay. For example, the supplemental content server may determine that the offer from a supplemental content server aligns with user preferences, a demographic relevance, a content engagement history, a contextual relevance, a target bid value, or any other suitable condition. In some embodiments, after evaluating each offer, the supplemental content server selects supplemental content and sends it back to the MoQ relay, e.g., based on the offer of the respective supplemental content aligning with one or more conditions. In some embodiments, the supplemental content server selects the supplemental content corresponding to the offer with the highest bid value. In some embodiments, the supplemental content bidding and selection process is performed directly at the MoQ relay. In such embodiments, the MoQ relay performs the supplemental content bidding and selection process locally, rather than querying the supplemental content server. When the MoQ relay detects a placeholder group, it can immediately initiate the supplemental content bidding process and subsequently select supplemental content, without requiring communication with an external server, which might otherwise introduce additional latency in delivering the supplemental content. In some embodiments, the supplemental content selected by the supplemental content server is an advertisement.

In some embodiments, the supplemental content selection process is performed before the MoQ relay receives a group of placeholder objects indicating an insertion opportunity for supplemental content. In such embodiments, the MoQ relay receives the metadata structure and/or the supplemental content before detecting any placeholder objects and caches the metadata structure and/or the supplemental content. When a placeholder group is detected, the MoQ relay can then retrieve the supplemental content from its cache, thereby preventing any latency increase that could be caused by the supplemental content selection process.

In some approaches, by delegating the selection process for personalized supplemental content to the MoQ relay, the streaming architecture decentralizes the processing tasks thereby reducing the computational load required at the publishing server and user devices. This enables the streaming architecture to efficiently deliver supplemental content to multiple regions while preserving personalization on either a per-user device or per-MoQ relay basis. In some embodiments, this decentralized processing approach enables the streaming architecture to become more scalable (e.g., by being able to add more MoQ relays) and deliver content at lower latency (e.g., due fewer instances of network congestion), while also being able to provide personalized supplemental content through each MoQ relay based on region, personalized supplemental content data, a special event, or any other suitable criteria. In some embodiments, a user device connects to an MoQ relay to subscribe to an MoQ stream based on a determination that the personalized supplemental content data (or a portion of the supplemental content data) of the particular user device is similar to or matches personalized supplemental content data of other user devices already connected to the MoQ relay. Such embodiments enable the MoQ relay to transmit the same supplemental content to a plurality of user devices while maintaining higher ad impressions, e.g., by tailoring the personalized supplemental content to a data point/value that is shared between the user devices.

FIG. 1D depicts an illustrative example in which supplemental content server 112 (e.g., corresponding to supplemental content source 602 of FIG. 6) transmits group 114 corresponding to supplemental content to MoQ relay 104 (e.g., corresponding to MoQ relay 616 of FIG. 6), enabling MoQ relay 104 to replace placeholder group 110 with group 114 before transmitting the modified MoQ stream to the user devices, in accordance with some embodiments of this disclosure. At step 8(a) supplemental content server 112 transmits group 114 corresponding to the selected supplemental content (e.g., a breaking news alert) to the MoQ relay 104. In some embodiments, the transmission of group 114 is preceded by supplemental content server 112 transmitting a metadata structure to MoQ relay 104 describing what supplemental content was selected and information for how MoQ relay 104 can request groups of the particular supplemental content. In such embodiments, step 8(a) is performed by supplemental content server 112 when it receives a request for the supplemental content based on the metadata structure information from MoQ relay 104. In some embodiments, this metadata structure includes information for one or more supplemental content items. In embodiments where the supplemental content is one or more advertisements the metadata structure may be an ad pod.

In step 9, after receiving (e.g., via I/O circuitry 620 of FIG. 6) group 114, MoQ relay 104 discards placeholder group 110 received from NetStream server 102 and replaces that portion of the Champ League MoQ stream with group 114 corresponding to the supplemental content. In some embodiments, instead of discarding placeholder group 110, MoQ relay 104 overwrites the objects of placeholder group 110 with the objects of group 114. At step 10(a), MoQ relay 104 then transmits (e.g., via I/O circuitry 620 of FIG. 6) the MoQ stream for Champ League with the inserted supplemental content to user devices 106. The supplemental content (e.g., breaking news) then gets displayed at user devices 106. When MoQ relay 104 determines that the time for inserting supplemental content is over (e.g., based on a timer, tracking the number of placeholder objects, or any other suitable tracking method), it resumes transmitting the track of groups for Champ League content. In some embodiments, after inserting supplemental content into the MoQ stream, the MoQ relay caches the supplemental content locally. In such embodiments, the cached supplemental content may be reused when the MoQ relay subsequently detects another placeholder group. This allows the MoQ relay to efficiently provide supplemental content tailored to connected client devices without being required to repeat the supplemental content selection process.

In some embodiments, the described streaming architecture does not require any software updates, maintenance needs, or system changes from the user device perspective since every aspect of the supplemental content selection and insertion process is coordinated by the MoQ relay. In some embodiments, the MoQ relay transmits the same supplemental content to all of its subscribed devices (e.g., in embodiments where the MoQ relay transmits one request for supplemental content based on aggregated personalized supplemental content data from all subscribed devices). In some embodiments, the MoQ relay transmits the same supplemental content to a subset of subscribed devices (e.g., based on a determination that the personalized supplemental content data of the subset of subscribed devices shares one or more common characteristics). In some embodiments, the MoQ relay transmits unique supplemental content to each of its subscribed devices (e.g., in embodiments where the MoQ relay transmits a unique request for supplemental content for each set of personalized supplemental content data from one user device). In some embodiments, the MoQ relay transmits the same supplemental content to user devices connected to the MoQ relay that are subscribed to different MoQ streams.

In some embodiments, if the streaming architecture involves transmitting content through two or more MoQ relays, an upstream is responsible for orchestrating supplemental content selection and insertion (rather than the final MoQ relay that a set of user devices are subscribed to). For example, this may be done if the intention is to deliver the same supplemental content to a broad geographic region or cohort of user profiles sharing a user preference. In some embodiments, the upstream MoQ relay transmits the metadata structure describing the selected supplemental content down to the final relay, such that the final relay requests groups of the supplemental content from the supplemental content server. In some embodiments, the upstream MoQ relay also performs the supplemental content insertion process described in relation to FIG. 1D.

FIG. 1E depicts an illustrative example for MoQ relay 104 (e.g., corresponding to MoQ relay 604 of FIG. 6) receiving (e.g., via I/O circuitry 612 of FIG. 6) an indication that no supplemental content is available, causing it to transmit the MoQ stream with placeholder group 110 still included, in accordance with some embodiments of this disclosure. In some embodiments, as shown in step 8(b), supplemental content server 112 responds to MoQ relay 104's request for supplemental content with an indication that no supplemental content was selected (e.g., because no supplemental content was available, because no supplemental content provider offered to supply their supplemental content, because there is/was a connection disruption/issue between MoQ relay 104 and supplemental content server 112, or for any other suitable reason). Upon receiving this response, MoQ relay 104 proceeds to step 10(b) and continues to transmit the MoQ stream for Champ League with placeholder group 110 still included. In such embodiments, the frames corresponding to the placeholder group 110 get displayed at user devices 106. For example, these frames may be a still frame or premade content from the publisher with messaging such as “Champ League will be right back.” In some embodiments, the content corresponding to placeholder group 110 may be a default weather, news, or traffic update, a “Will be right back” message, a generic promotional offer from the publisher, or any other suitable embodiment of placeholder content.

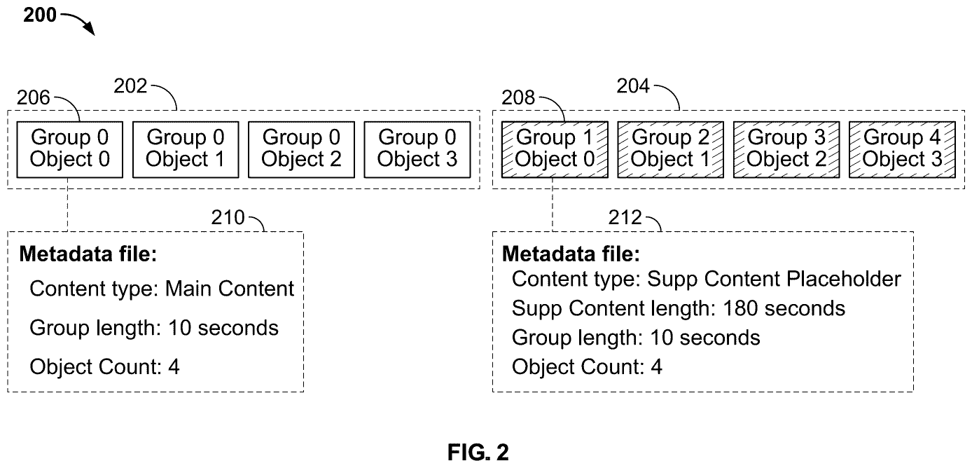

FIG. 2 depicts an illustrative example of a track of objects (e.g., objects of groups 108, 110 of FIGS. 1A-1E) transported over an MoQ stream, in accordance with some embodiments of this disclosure. In some embodiments, the data stream for transporting media content over an MoQ stream is called a track, the track consisting of a sequence of groups, each group consisting of a collection of objects. For example, FIG. 2 depicts track 200, consisting of group 202 and group 204, each group consisting of a collection of four groups. In some embodiments, each object corresponds to data for a chunk (i.e., a segment) of the media content. In some embodiments, each object corresponds to data for one frame of the media content. In some embodiments, a group consists of objects for a set of frames whose decoding is dependent on the same keyframe (e.g., I-frame wherein the group is like a group of pictures (GOP)). In some embodiments, when a user device requests to subscribe to a particular MoQ stream for media content, the user device is requesting the track corresponding to that media content, whereas the groups are the join points of that track.

In some embodiments, the first object of each group has metadata assigned to it (e.g., by the publishing server). For example, object 206 of group 202 has metadata file 210 attached to it. Metadata file 210 indicates that group 202 corresponds to main content (e.g., frames of Champ League), includes 10 seconds of content, and is four objects long. As another example, object 208 of group 204 has metadata file 212 attached to it. Metadata file 212 indicates that group 204 is a supplemental content placeholder, includes 10 seconds of placeholder content, and is four objects long. In some embodiments, the metadata file for a placeholder group also includes a parameter indicating how much supplemental content can be inserted into the MoQ stream. For example, metadata file 212 has the parameter “Supp content length: 180 seconds” indicating that this an opportunity to insert 180 seconds of supplemental content. In some embodiments, the metadata file format is a JSON, XML, YAML, CSV, RDF, or any other suitable metadata format.

In some embodiments, when an MoQ relay (e.g., MoQ relay 104 of FIGS. 1A-1E and/or MoQ relay 616 of FIG. 6) receives group 204, it can read metadata file 212 from metadata from object 208 to determine that the group corresponds to a placeholder group, thus prompting it to send a request for supplemental content to a supplemental content server 112. In some embodiments, when the MoQ relay receives supplemental content, it discards the placeholder group and inserts the supplemental content. In such embodiments, the supplemental content can be longer than the placeholder group (e.g., the length of the supp content length parameter). In some embodiments, when the MoQ relay receives supplemental content, it overwrites the objects of the placeholder group with the groups of the supplemental content (e.g., if the number of supplemental content objects matches or is less than the number of placeholder objects).

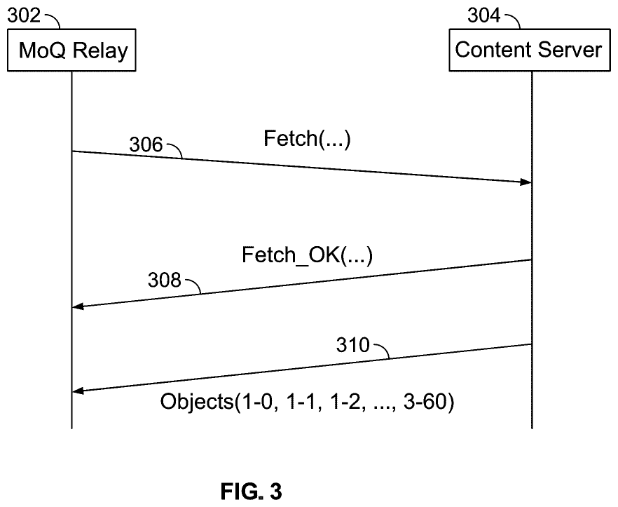

FIG. 3 depicts an illustrative sequence diagram for establishing a connection to fetch content (e.g., via the supplemental content request described in relation to FIG. 1C) via an MoQ stream, in accordance with some embodiments of this disclosure. In some embodiments, MoQ relay 302 (e.g., corresponding to devices 500, 501 of FIG. 5 and/or computing devices 607, 608, 610 of FIG. 6) transmits (e.g., via I/O circuitry 612 of FIG. 6) fetch request 306 to content server 304 (e.g., corresponding to publishing server 604 of FIG. 6) as a request to subscribe to an MoQ stream of content server 304. In some embodiments, upon receiving (e.g., via I/O circuitry 620 of FIG. 6) fetch request 306, content server 304 transmits fetch_ok response 308 (e.g., based on determining that MoQ relay 302 is authorized to access content from content server 304). In some embodiments, along with the response confirming that the pub/sub connection has been established, content server 304 simultaneously begins transmitting MoQ Stream 310 (e.g., Objects(1-0, 1-1, 1-2, . . . , 3-60)) corresponding to media content transmitted via the subscribed MoQ stream. In such embodiments, by initiating content transmission via one round trip between MoQ relay 302 and content server 304 (e.g., a two-way handshake), content server 304 is able to reduce the latency of content transmission by not waiting for a response from MoQ relay 302 confirming that it received the fetch_ok response 308 (e.g., as is required for a three-way handshake).

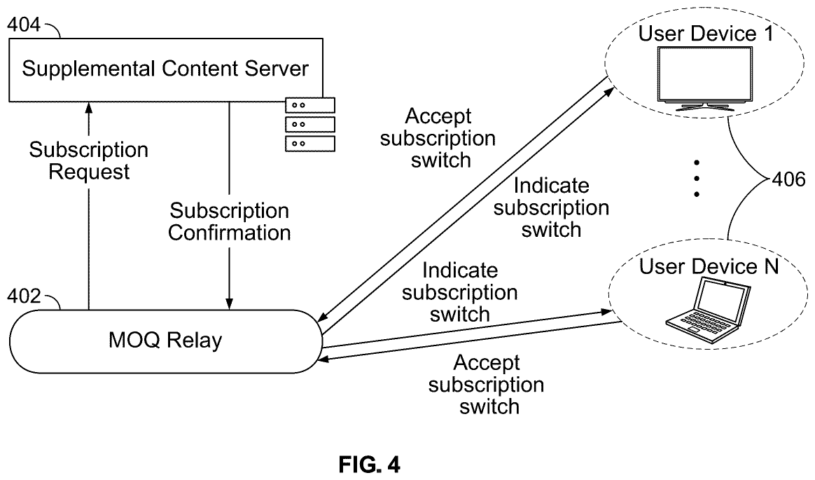

FIG. 4 depicts is illustrative example for an MoQ relay orchestrating a subscription switch, in accordance with some embodiments of this disclosure. In some embodiments, the supplemental content selected for replacing the placeholder group (e.g., placeholder group 110 of FIGS. 1A-1E) is live content. For example, the supplemental content may be a live breaking news report, a live emergency alert, a Quality Value Convenience (QVC) channel, or any other suitable embodiment of live supplemental content. In such embodiments, the MoQ relay (e.g., MoQ relay 104 of FIGS. 1A-1E and/or MoQ relay 616 of FIG. 6) may facilitate a subscription switch operation from the MoQ stream transmitted by the publisher to an MoQ stream transmitted by the supplemental content server. In some embodiments, the process of switching subscriptions begins with MoQ relay 402 determining that the supplemental content to be inserted into the MoQ stream is live content. For example, the MoQ relay may receive (e.g., via I/O circuitry 620 of FIG. 6) a metadata structure from supplemental content server 404 indicating that the supplemental content it selected is live content. In some embodiments, MoQ relay 402 then transmits a request (e.g., fetch request 306 of FIG. 3) to subscribe to an MoQ stream of the supplemental content server. In some approaches, supplemental content server 404 then transmits a response confirming subscription to the MoQ stream. In some embodiments, supplemental content server 404 begins transmitting the MoQ Stream (e.g., MoQ stream 310 of FIG. 3) of supplemental content in conjunction with the confirmation response. Once MoQ relay 402 determines that the time for transmitting supplemental content expired (e.g., based on monitoring a timer or determining a time associated with the placeholder objects), MoQ relay 402 switches back to subscribing to the MoQ stream from the publishing server.

In some embodiments, the MoQ relay also transmits a message to each user devices 406 (i.e., user devices receiving the supplemental content) that a subscription from a publishing server to supplemental content server 404 is being made. In some embodiments, user devices 406 respond with a message accepting the subscription switch. The interaction between MoQ relay 402 and user devices 406 can be done simultaneous to, subsequent to, or prior to the subscription-switch interaction with supplemental content server 404.

In some embodiments, the MoQ relay includes a subscription ID in the messages to the supplemental content server and user devices. The subscription ID corresponds to the current subscription of the user devices and is reused across the switch from the publisher to the supplemental content server to facilitate delivery to the correct user devices. In some embodiments, the MoQ relay's request to subscribe to an MoQ stream from the supplemental content server includes a “newTrackName” parameter, which identifies the live supplemental content track the relay intends to receive. In some embodiments, the response from the supplemental content server includes a “trackAlias” command which identifies the track alias to be used for the new track of supplemental content.

FIGS. 5-6 show illustrative devices and systems for causing simultaneous display of portions of a media asset, in accordance with some embodiments of this disclosure. FIG. 5 shows generalized embodiments of illustrative devices 500 and 501, which may correspond to, e.g., user devices 106 of FIG. 1 and/or user devices 406 of FIG. 4. For example, device 500 may be a smartphone device, a tablet, a virtual reality or augmented reality device, or any other suitable device capable of accessing content items stored at a server (e.g., a content server) over a communication network (e.g., network 606). In another example, device 501 may be a user television equipment system or device. Device 501 may include set-top box 515. Set-top box 515 may be communicatively connected to microphone 516, audio output equipment (e.g., speaker or headphones 514), and display 512. In some embodiments, microphone 516 may receive audio corresponding to a voice command related to recording content items. In some embodiments, display 512 may be a television display or a computer display. In some embodiments, set-top box 515 may be communicatively connected to user input interface 510. In some embodiments, user input interface 510 may be a remote-control device. Set-top box 515 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 6. In some embodiments, device 500 may comprise any suitable number of sensors, as well as a GPS module (e.g., in communication with one or more servers and/or cell towers and/or satellites) to ascertain a location of device 500.

Each one of device 500 and device 501 may receive content and data via input/output (I/O) path 502. I/O path 502 may provide content (e.g., broadcast programming, on-demand programming, Internet content, content available over a local area network (LAN) or wide area network (WAN), and/or other content) and data to control circuitry 504, which may comprise processing circuitry 506 and storage 508. Control circuitry 504 may be used to send and receive commands, requests, and other suitable data using I/O path 502, which may comprise or correspond to I/O circuitry 502. I/O path 502 may connect control circuitry 504 (and specifically processing circuitry 506) to one or more communications paths (described below). I/O functions may be provided by one or more of these communications paths, but are shown as a single path in FIG. 5 to avoid overcomplicating the drawing. While set-top box 515 is shown in FIG. 6 for illustration, any suitable computing device having processing circuitry, control circuitry, and storage may be used in accordance with the present disclosure. For example, set-top box 515 may be replaced by, or complemented by, a personal computer (e.g., a notebook, a laptop, a desktop), a smartphone (e.g., device 500), a tablet, a network-based server hosting a user-accessible client device, a non-user-owned device, any other suitable device, or any combination thereof.

Control circuitry 504 may be based on any suitable control circuitry such as processing circuitry 506. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 504 executes instructions for the media application stored in memory (e.g., storage 508). Specifically, control circuitry 504 may be instructed by the media application to perform the functions discussed above and below. In some implementations, processing or actions performed by control circuitry 504 may be based on instructions received from the storage management application.

In client/server-based embodiments, control circuitry 504 may include communications circuitry suitable for communicating with a storage management server (e.g., a cloud DVR, content database) or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 5, the instructions may be stored in storage 508 and executed by control circuitry 504 of device 500.

In some embodiments, the media application may be a client/server application where only the client application resides on device 500 (e.g., user devices 106), and a server application resides on an external server (e.g., publishing server 604 and/or MoQ relay 616 of FIG. 6). For example, the media application may be implemented partially as a client application on control circuitry 504 of device 500 and partially on publishing server 604 as a server application running on control circuitry 611. Publishing server 604 may be a part of a local area network with one or more of device 500 or may be part of a cloud computing environment accessed via the internet. In a cloud computing environment, various types of computing services for performing searches on the internet or informational databases, providing access to content items, providing storage (e.g., for a database) or parsing data are provided by a collection of network-accessible computing and storage resources (e.g., publishing server 604 of FIG. 6), referred to as “the cloud.” When executed by control circuitry of publishing server 604, the media application may instruct control circuitry 504 or control circuitry 611 to perform processing tasks for the client device and facilitate the simultaneous presentation of multiple portions of a media asset.

Control circuitry 504 may include communications circuitry suitable for communicating with a cloud DVR, publishing servers, MoQ relays, supplemental content servers, a table or database server, or any other networks or servers The instructions for carrying out the above mentioned functionality may be stored on a server (which is described in more detail in connection with FIG. 6). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 6). In addition, communications circuitry may include circuitry that enables peer-to-peer communication of computing devices, or communication of computing devices in locations remote from each other (described in more detail below).

Memory may be an electronic storage device provided as storage 508 that is part of control circuitry 504. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 508 may be used to store various types of content described herein as well as media application data described above. Nonvolatile memory may also be used (e.g., to launch a boot-up routine and other instructions). Cloud-based storage, described in relation to FIG. 5, may be used to supplement storage 508 or instead of storage 508.

Control circuitry 504 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 504 may also include scaler circuitry for upconverting and down converting content into the preferred output format of device 500. Control circuitry 504 may also include digital-to-analog converter circuitry and analog-to-digital converter circuitry for converting between digital and analog signals. The tuning and encoding circuitry may be used by device 500, 501 to receive and to display, to play, or to record content. The tuning and encoding circuitry may also be used to receive content item data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, PIP functions, multiple-tuner recording, etc.). If storage 508 is provided as a separate device from device 500, the tuning and encoding circuitry (including multiple tuners) may be associated with storage 508.

Control circuitry 504 may receive instruction from a user by way of user input interface 510. User input interface 510 may be any suitable user interface, such as a remote control, mouse, trackball, keypad, keyboard, touch screen, touchpad, stylus input, joystick, voice recognition interface, or other user input interfaces. Display 512 may be provided as a stand-alone device or integrated with other elements of each one of device 500 and device 501. For example, display 512 may be a touchscreen or touch-sensitive display. In such circumstances, user input interface 510 may be integrated with or combined with display 512. In some embodiments, user input interface 510 includes a remote-control device having one or more microphones, buttons, keypads, any other components configured to receive user input or combinations thereof. For example, user input interface 510 may include a handheld remote-control device having an alphanumeric keypad and option buttons. In a further example, user input interface 510 may include a handheld remote-control device having a microphone and control circuitry configured to receive and identify voice commands and transmit information to set-top box 515.

Audio output equipment 514 may be integrated with or combined with display 512. Display 512 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 512. Audio output equipment 514 may be provided as integrated with other elements of each one of device 500 and device 501 or may be stand-alone units. An audio component of videos and other content displayed on display 512 may be played through speakers (or headphones) of audio output equipment 514. In some embodiments, audio may be distributed to a receiver (not shown), which processes and outputs the audio via speakers of audio output equipment 514. In some embodiments, for example, control circuitry 504 is configured to provide audio cues to a user, or other audio feedback to a user, using speakers of audio output equipment 514. There may be a separate microphone 516 or audio output equipment 514 may include a microphone configured to receive audio input such as voice commands or speech. For example, a user may speak letters or words that are received by the microphone and converted to text by control circuitry 504. In a further example, a user may voice commands that are received by a microphone and recognized by control circuitry 504. Camera 518 may be any suitable video camera integrated with the equipment or externally connected. Camera 518 may be a digital camera comprising a charge-coupled device (CCD) and/or a complementary metal-oxide semiconductor (CMOS) image sensor. Camera 518 may be an analog camera that converts to digital images via a video card.

The media application may be implemented using any suitable architecture. For example, it may be a stand-alone application wholly implemented on each one of device 500 and device 501. In such an approach, instructions of the application may be stored locally (e.g., in storage 508), and data for use by the application is downloaded on a periodic basis (e.g., from an out-of-band feed, from an Internet resource, or using another suitable approach). Control circuitry 504 may retrieve instructions of the application from storage 508 and process the instructions to provide storage management functionality and generate any of the displays discussed herein. Based on the processed instructions, control circuitry 504 may determine what action to perform when input is received from user input interface 510. For example, movement of a cursor on a display up/down may be indicated by the processed instructions when user input interface 510 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 504 may allow a user to provide user profile information or may automatically compile user profile information. For example, control circuitry 504 may access and monitor network data, video data, audio data, processing data, content consumption data and user interaction data. Control circuitry 504 may obtain all or part of other user profiles that are related to a particular user (e.g., via social media networks), and/or obtain information about the user from other sources that control circuitry 504 may access. As a result, a user can be provided with a unified experience across the user's different devices.

In some embodiments, the media application is a client/server-based application. Data for use by a thick or thin client implemented on each one of device 500 and device 501 may be retrieved on-demand by issuing requests to a server remote to each one of device 500 and device 501. For example, the remote server may store the instructions for the application in a storage device. The remote server may process the stored instructions using circuitry (e.g., control circuitry 504) and generate the displays discussed above and below. The client device may receive the displays generated by the remote server and may display the content of the displays locally on device 500. This way, the processing of the instructions is performed remotely by the server while the resulting displays (e.g., that may include text, a keyboard, or other visuals) are provided locally on device 500. Device 500 may receive inputs from the user via user input interface 510 and transmit those inputs to the remote server for processing and generating the corresponding displays. For example, device 500 may transmit a communication to the remote server indicating that an up/down button was selected via user input interface 510. The remote server may process instructions in accordance with that input and generate a display of the application corresponding to the input (e.g., a display that moves a cursor up/down). The generated display is then transmitted to device 500 for presentation to the user.

In some embodiments, the media application may be downloaded and interpreted or otherwise run by an interpreter or virtual machine (run by control circuitry 504). In some embodiments, the media application may be encoded in the ETV Binary Interchange Format (EBIF), received by control circuitry 504 as part of a suitable feed, and interpreted by a user agent running on control circuitry 504. For example, the media application may be an EBIF application. In some embodiments, the media application may be defined by a series of JAVA-based files that are received and run by a local virtual machine or other suitable middleware executed by control circuitry 504. In some of such embodiments (e.g., those employing MPEG-2 or other digital media encoding schemes), media application may be, for example, encoded and transmitted in an MPEG-2 object carousel with the MPEG audio and video packets of a program.

FIG. 6 shows illustrative devices and systems for providing one or more portions of the media asset, in accordance with some embodiments of this disclosure. Computing devices 607, 608, 610 (e.g., which may correspond to user devices 106 of FIG. 1A) may be coupled to communication network 606. Communication network 606 may be one or more networks including the Internet, a mobile phone network, mobile voice, or data network (e.g., a 5G, 4G, or LTE network), cable network, public switched telephone network, or other types of communication network or combinations of communication networks. Paths (e.g., depicted as arrows connecting the respective devices to the communication network 606) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 6 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The computing devices may also communicate with each other directly through an indirect path via communication network 606.

System 600 may comprise supplemental content source 602 (e.g., corresponding to supplemental content server 112 of FIGS. 1C-1E and/or supplemental content server 404 of FIG. 4), one or more publishing servers 604 (e.g., corresponding to NetStream server 102 of FIGS. 1A-1B), and one or more MoQ relays 616 (e.g., corresponding to MoQ relay 104 of FIGS. 1A-1E and/or MoQ relay 402 of FIG. 4). In some embodiments, the media application may be executed at one or more of control circuitry 611 of publishing server 604 (and/or control circuitry of computing devices 607, 608, 610 and/or control circuitry 618 of MoQ relay 616). In some embodiments, manifest file 300 of FIG. 3, first manifest file 422 and/or and second manifest file 424 of FIG. 4, may be stored at storage 614 or content database 605 maintained at or otherwise associated with publishing server 604, and/or at storage 622 and/or at storage of one or more of computing devices 607, 608, 610.

In some embodiments, publishing server 604 may include control circuitry 611 and storage 614 (e.g., RAM, ROM, Hard Disk, Removable Disk, etc.). Storage 614 may store one or more databases. Publishing server 604 may also include an input/output path 612. I/O path 612 may provide content consumption data, user interaction data, device information, or other data, over a local area network (LAN) or wide area network (WAN), and/or other content and data to control circuitry 611, which may include processing circuitry, and storage 614. Control circuitry 611 may be used to send and receive commands, requests, and other suitable data using I/O path 612, which may comprise or correspond to I/O circuitry. I/O path 612 may connect control circuitry 611 (and specifically control circuitry) to one or more communications paths.

Control circuitry 611 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 611 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 611 executes instructions for an emulation system application stored in memory (e.g., the storage 614). Memory may be an electronic storage device provided as storage 614 that is part of control circuitry 611.

MoQ relay 616 may comprise control circuitry 618, I/O path 620 and storage 622, which may be implemented in a similar manner as control circuitry 611, I/O path 612 and storage 624, respectively, of publishing server 604. MoQ relay 616 may be configured to be in communication with one or more of computing devices 607, 608, 610 and publishing server 604 over communication network 606, and may be configured to provide content from a pool of shared content to subscribers associated with a shared pool of copies of content items. In some embodiments, a plurality of MoQ relays 616 may be strategically located at various geographic locations, configured to store (e.g., cache) content items for delivery to various shared pools of copies for a plurality of MoQ stream subscribers.

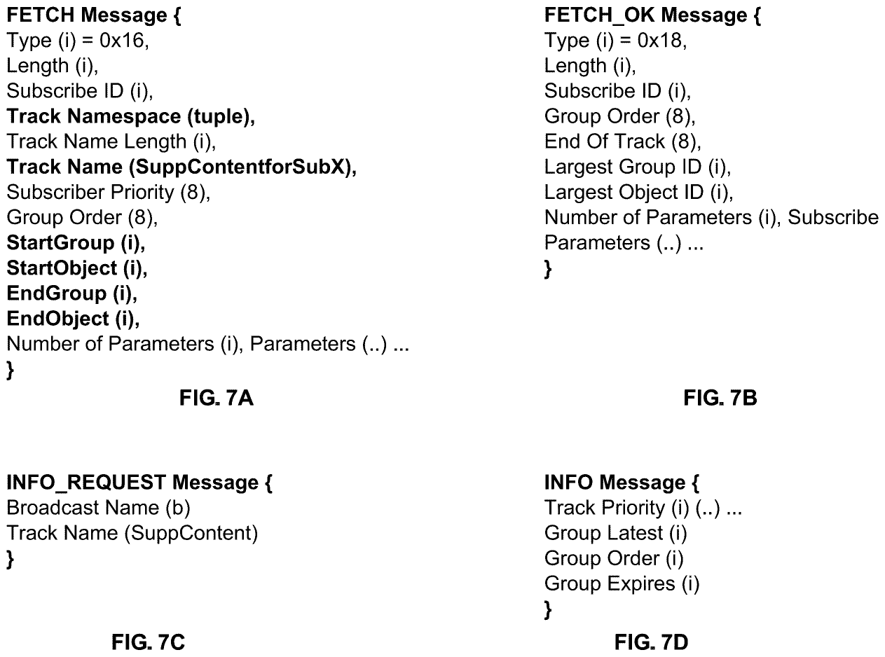

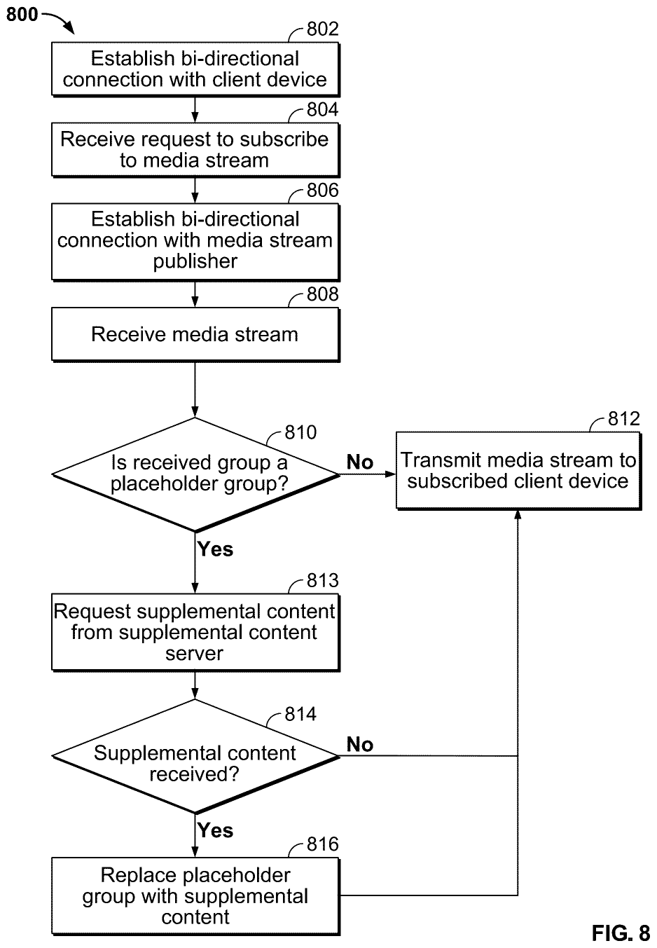

FIG. 7A depicts an illustrative request for fetching supplemental content, in accordance with some embodiments of this disclosure. In some embodiments, the MoQ relay (e.g., MoQ relay 104 of FIGS. 1A-1E and/or MoQ relay 616 of FIG. 6) transmits the FETCH message (e.g., fetch request 306 of FIG. 3) shown in FIG. 7A if it previously received a metadata structure including identifiers for relevant supplement content. In such embodiments, the MoQ relay references the metadata structure to generate and transmit a request for supplemental content referenced in the metadata structure to a supplemental content server. FIG. 7B depicts an illustrative fetch response for supplemental content, in accordance with some embodiments of this disclosure. In some embodiments, the supplemental content server responds with a FETCH_OK response (e.g., fetch_ok response 308 of FIG. 3) including metadata regarding the supplemental content it is transmitting to the MoQ relay.

FIG. 7C depicts an illustrative message for inquiring about supplemental content availability, in accordance with some embodiments of this disclosure. In some embodiments, the MoQ relay does not receive a metadata structure identifying supplemental content. In such embodiments, the MoQ relay transmits an INFO_REQUEST message, as shown in FIG. 7C, which inquires about any supplemental content that is currently available. FIG. 7D depicts an illustrative confirmation message for available supplement content, in accordance with some embodiments of this disclosure. In embodiments where the supplemental content selects available content for subscribers of the MoQ relay, it transmits back an INFO message, as shown in FIG. 7D, including metadata for the supplemental content it selected.

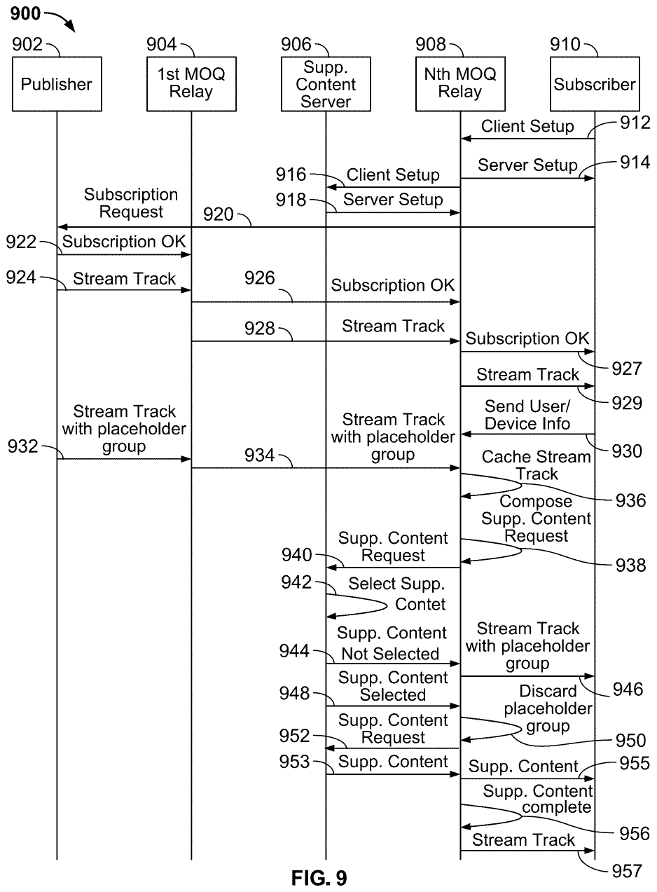

FIG. 8 depicts is an illustrative flowchart for process 800 performed at an MoQ relay receiving and transmitting a media stream via bi-directional connections between a publishing server and client device. Process 800 begins at step 802, where an MoQ relay (e.g., MoQ relay 104 of FIGS. 1A-1E and/or MoQ relay 616 of FIG. 6) establishes (e.g., via I/O circuitry 620 of FIG. 6) a bi-directional connection with a client device (e.g., devices 500, 501 of FIG. 5 and/or computing devices 607, 608, 610 of FIG. 6). In some embodiments, the bi-directional connection is established using the QUIC transport protocol. After the bi-directional connection to the client device is established (e.g., via I/O circuitry 620 of FIG. 6), the MoQ relay receives a request to subscribe to a media stream (e.g., an MoQ stream) from the client device (e.g., via I/O circuitry 502 of FIG. 5). In some embodiments, the client device transmits (e.g., via I/O circuitry 502) the subscription request to the MoQ relay based on user input (e.g., via user input interface 510) indicating a desire to subscribe to the media stream. In some embodiments, the client device automatically initiates the subscription request upon receiving a message that the media stream is available.

At step 806, MoQ relay (e.g., MoQ relay 104 of FIGS. 1A-1E and/or MoQ relay 616 of FIG. 6) establishes (e.g., via I/O circuitry 620 of FIG. 6) a bi-directional connection with the publisher (e.g., NetStream server 102 of FIG. 1A-1B and/or publishing server 604 of FIG. 6), of the media stream. In some embodiments, the MoQ relay establishes the bi-directional connection with the publishing server prior to establishing the bi-directional connection with the client device. For example, the MoQ relay may establish an initial bi-directional connection with the publishing server to determine which media content is available, caching (e.g., at storage 622) that information. Thus, when a user device queries the MoQ relay for available MoQ streams, the relay can promptly provide the necessary details without involving the publishing server, thereby reducing the latency between the relay and the client device.

At step 808, the MoQ relay (e.g., MoQ relay 104 of FIGS. 1A-1E and/or MoQ relay 616 of FIG. 6) receives (e.g., via I/O circuitry 620 of FIG. 6) the media stream corresponding to subscription request. In some embodiments, the MoQ relay establishes the bi-directional connection and receives the media stream using the process described in relation to FIG. 3. In some approaches, the media stream is made up of a track of groups, each group consisting of objects as is described in relation to FIG. 2. In some embodiments, the publishing server assigns metadata to the first object (or any other suitable object) of the group, e.g., to indicate the type of content, the length of the group, or any other suitable metadata. At step 810, the MoQ relay inspects (e.g., via control circuitry 618 of FIG. 6) the media stream track for metadata indicating that a received group includes placeholder objects (e.g., an insertion opportunity for supplemental content). If, at step 810, the MoQ relay determines (e.g., via control circuitry 618 of FIG. 6) that a received group is not a placeholder group, process 800 proceeds to step 812. In step 812, the MoQ relay transmits (e.g., via I/O circuitry 620 of FIG. 6) the media stream composed of non-placeholder groups to the subscribed client devices. In some embodiments, the MoQ relay transmits the media stream using the MoQ transport protocol.

If, at step 810, the MoQ relay determines (e.g., via control circuitry 618 of FIG. 6) that a received group is a placeholder group, process 800 proceeds to step 813. At step 813, the MoQ relay generates a request e.g., via control circuitry 618 of FIG. 6) for supplemental content and transmits the request (e.g., via I/O circuitry 620 of FIG. 6) to a supplemental content server (e.g., supplemental content server 112 of FIGS. 1C-1E and/or supplemental content source 602 of FIG. 6) via a bi-directional connection. In some embodiments, the request includes personalized supplemental content data, enabling the supplemental content server to tailor its selection based on information corresponding to the subscribed client device and/or a user profile associated with the subscribed client device.

Process 800 then moves to step 814 where the MoQ relay determines (e.g., via control circuitry 618 of FIG. 6) whether it received supplemental content from the supplemental content server (e.g., supplemental content source 602 of FIG. 6). If the MoQ relay determines that no supplemental content was received, process 800 proceeds to step 812 where the MoQ relay transmits (e.g., via I/O circuitry 620 of FIG. 6) the media stream composed of the placeholder group to the subscribed client devices. In some embodiments, the MoQ relay determines that no supplemental content was received based on a response from the supplemental content server indicating that no supplemental content was selected. In some embodiments, if the MoQ relay does not receive a response from the supplemental content server within a predefined threshold time after sending its request (e.g., due to network connection issues between the MoQ relay and the supplemental content server), it determines that no supplemental content has been received.

If the MoQ relay determines (e.g., via control circuitry 618 of FIG. 6) that supplemental content was received, process 800 proceeds to step 816 where the MoQ relay replaces (e.g., via control circuitry 618 of FIG. 6) the placeholder group with the received supplemental content. In some embodiments, the MoQ relay establishes the bi-directional connection and receives the supplemental content using the process described in relation to FIG. 3. In some embodiments, the MoQ relay performs (e.g., via control circuitry 618 of FIG. 6) step 816 by discarding the placeholder group and inserting groups of the supplemental content. In some embodiments, the MoQ relay performs (e.g., via control circuitry 618 of FIG. 6) step 816 by overwriting the objects of the placeholder group with objects of the supplemental content. After replacing the placeholder group with the supplemental content, the process continues to step 812, where the MoQ relay transmits (e.g., via I/O circuitry 620 of FIG. 6) the media stream composed of the supplemental content to the subscribed client devices.

FIG. 9 shows sequence diagram 900 for the process of MoQ relays coordinating with publishers and supplemental content servers to provide media content with embedded supplemental content to subscribers, in accordance with some embodiments of this disclosure. In some embodiments, sequence diagram 900 involves publisher 902 (e.g., corresponding to NetStream server 102 of FIGS. 1A-1B and/or publishing server 604 of FIG. 6), first MoQ relay 904, supplemental content server 906 (e.g., corresponding to supplemental content server 112 of FIGS. 1C-1E and/or supplemental content source 602 of FIG. 6), N^{th} MoQ relay 908 (e.g., corresponding to MoQ relay 104 of FIGS. 1A-1E and/or MoQ relay 402 of FIG. 4 and/or MoQ relay 616 of FIG. 6) and subscriber 910 (e.g. corresponding to user devices 106 and/or user devices 406 and/or devices 500, 501 and/or computing devices 607, 608, 610).

Sequence diagram 900 begins at 912, where subscriber 910 transmits a client setup message (e.g., a control message) requesting a bi-directional connection between itself and N^{th} MoQ relay 908. At 914, N^{th} MoQ relay 908 replies with server setup 914 which confirms that a bidirectional connection between itself and subscriber 910 has been established. In some embodiments, the streaming architecture for providing media content includes multiple MoQ relays that feed other MoQ relays and that each have their own subscribers. In some embodiments, the MoQ relay that receives transmissions from other MoQ relays and that is connected directly to subscribers is called a “final relay.” In sequence diagram 900, N^{th} MOQ relay 908 is a final relay since it has a bi-directional connection between itself and subscriber 910. first MoQ relay 904 is an upstream MoQ relay. In some embodiments, first MoQ relay is responsible for distributing content over a broad region of MoQ relays dedicated to servicing smaller areas of subscribers.

After establishing the bi-directional connection with subscriber 910, N^{th} MoQ relay 908 establishes a bi-directional connection with supplemental content server 906. This bi-directional connection is established by N^{th} MoQ relay 908 transmitting a client setup message at 916, and supplemental content server 906 replying with a server setup message at 918 (similar to the messages exchanged between N^{th} MoQ relay 908 and subscriber 910 at 912 and 914). In some embodiments, after connecting with subscriber 910, N^{th} MoQ relay 908 establishes a bi-directional connection with supplemental content server 906. This arrangement enables the relay to efficiently request and receive supplemental content whenever the need for supplemental content arises in the future.

At 920, subscriber 910 transmits a subscription request for a particular media stream to publisher 902. In some embodiments, the subscription request is transmitted through a series of relays (e.g., N^{th} MoQ relay 908 to first MoQ Relay 904 to publisher 902). In some embodiments, the subscription request (e.g., fetch request 306 of FIG. 3) is transmitted directly to publisher 902. In response to receiving the subscription request, publisher 902 transmits a message confirming subscriber 910's subscription to the particular media stream. At 922, the confirmation gets transmitted to first MoQ relay 904, which routes it to N^{th} MoQ relay 908 at 926, which then ultimately routes it to subscriber 910 at 927. In conjunction with the confirmation message, publisher 902 transmits the media stream track (e.g., MoQ stream 310 of FIG. 3) through first MoQ relay 904 and then N^{th} MoQ relay 908 at 924, 928, and 929. In some embodiments, when subscriber 910 receives the media stream track at 929 it processes the objects of the track into media data and plays the media.

In some embodiments, N^{th} MoQ relay 908 is configured to authorize subscription requests from subscribers. In such embodiments, the subscription request is received at N^{th} MOQ relay 908, and a confirmation response is sent by N^{th} MoQ relay 908 back to subscriber 910. In some embodiments, N^{th} MoQ relay 908 already has portions of the media stream track requested by subscriber 910 locally cached (e.g., at storage 622 of FIG. 6). In such embodiments, N^{th} MOQ relay 908 immediately transmits the cached media stream track to subscriber 910, enabling efficient delivery of the media stream without involving publisher 902.

At 930, subscriber 910 sends user and/or device information to N^{th} MoQ relay 908. In some embodiments, subscriber 910 is prompted to send the information based on receiving the media stream track at 929 (e.g., metadata included with the media stream indicates that it will include placeholders for personalized supplemental content).

At 932, the publisher transmits a portion of the media stream track that includes a placeholder group to first MoQ relay 904. In some embodiments, the placeholder group indicates an opportunity to insert supplemental content in the media stream track. At 934, first MoQ relay 904 then routes the media stream track to N^{th} MoQ relay 908. In some embodiments, N^{th} MoQ relay 908 is configured to inspect the media stream track for instances of placeholder groups. If N^{th} MoQ relay 908 detects a placeholder group (e.g., via metadata assigned to the first object of the placeholder group as is shown in FIG. 2), it caches the media stream track at 936, instead of immediately forwarding the track to subscriber 910. This gives N^{th} MoQ relay 908 relay time to request and receive supplemental content before continuing transmission of the MoQ relay.

At 938, N^{th} MoQ relay 908 composes a request for supplemental content (e.g., fetch request 306 of FIG. 3. In some embodiments, the request includes the user and/or device information received at 930. At 940, N^{th} MoQ relay 908 transmits the request to supplemental content server 906. At 942, supplemental content server 906 performs a selection process for supplemental content. In some embodiments, the selection process involves sending proposals to supplemental content providers such as weather services, news services, emergency services, sports media providers, advertisers, or any other qualified supplier, inviting them to supply supplemental content. In some embodiments, the content may be selected based on the user and/or device information (e.g., user preferences, geographic location, time of day, or any other suitable information).

At 944, supplemental content server 906 responds with a message indicating that no supplemental content was selected. In response to receiving the message that no supplemental content was selected, at 946, N^{th} MoQ relay 908 transmits the media stream track with the placeholder group to subscriber 910. The subscriber then plays the placeholder. In some embodiments, as in 948, supplemental content server 906 responds to the supplemental content request sent at 940, with a message indicating that supplemental content was selected. In some embodiments, this message includes a metadata structure with information on what supplemental content was selected and how to request it. N^{th} MoQ relay 908 then discards the placeholder group at 950.

At 952, N^{th} MoQ relay 908 transmits a request for the selected supplemental content to supplemental content server 906. In some embodiments, the request is formatted like the FETCH message depicted in FIG. 7A. In some embodiments, where no metadata structure is sent, the request may be formatted like the INFO_REQUEST message of FIG. 7C. At 953, supplemental content server 906 sends the requested supplemental content to N^{th} MoQ relay 908. In some embodiments, N^{th} MoQ relay 908 then inserts the supplemental content into the media stream track and transmits the media stream track with the supplemental content to the subscriber at 955. In some embodiments, due to the rapid request, reception, and insertion of supplemental content, media playback at subscriber 910 remains uninterrupted. In some embodiments, if N^{th} MoQ relay 908 determines that the process for requesting, receiving, and inserting supplemental content exceeds a threshold duration (e.g., one that would delay media playing at subscriber 910), it transmits the media stream track with the placeholder group still included.

At 956, N^{th} MoQ relay 908 determines that the time for transmitting supplemental content is over (e.g., based on a timer, tracking the number of placeholder objects, or any other suitable tracking method). At 957, N^{th} MoQ relay 908 then continues playing groups of the media stream track corresponding to the media content.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
establishing, by a Media-over-QUIC (MoQ) relay device, a bi-directional connection between the MoQ relay device and a client device;
based at least in part on receiving, from the client device, a request to subscribe to a media stream, establishing, by the MoQ relay device, a bi-directional connection between the MoQ relay device and a publisher of the media stream;
receiving, at the MoQ relay device, the media stream from the publisher to be transmitted to the client device via the bi-directional connection between the MoQ relay device and the client device, wherein the media stream comprises a plurality of groups, wherein each group comprises a respective plurality of objects;
determining, at the MoQ relay device, that an initial object of a particular group of the plurality of groups corresponds to a supplemental content insertion point;
transmitting, by the MoQ relay device, a request to a supplemental content server to provide supplemental content via a bi-directional connection between the MoQ relay device and the supplemental content server;
receiving, at the MoQ relay device, the supplemental content item via the bi-directional connection between the MoQ relay device and the supplemental content server;
preventing, at the MoQ relay device, transmission of at least the particular group of the plurality of groups to the client device via the bi-directional connection between the MoQ relay device and the client device; and
transmitting the supplemental content item in place of at least the particular group of the plurality of groups to the client device via the bi-directional connection between the MoQ relay device and the client device.

2. The method of claim 1, wherein the client device is one of a plurality of client devices, and wherein the MoQ relay device establishes a bi-directional connection between the MoQ relay device and each of the plurality of client devices, the method further comprising:
transmitting, by the MoQ relay device, the media stream and the supplemental content item to each of the plurality of client devices.

3. The method of claim 2, wherein the request to the supplemental content server to provide the supplemental content comprises at least one of:
preference information corresponding to the plurality of client devices, metadata related to the media stream, or a length of the supplemental content insertion point.

4. The method of claim 1, further comprising:
receiving a data structure identifying the supplemental content item, wherein the supplemental content item is received based on transmitting a request, by the MoQ relay device, using information from the data structure.

5. The method of claim 4, wherein the data structure identifying the supplemental content item is received based at least in part on:
the supplemental content server receiving a plurality of offers from a plurality of supplemental content providers to select their supplemental content, wherein the supplemental content item received at the MoQ relay device corresponds to a supplemental content provider whose offer was accepted.

6. The method of claim 4, wherein the data structure identifying the supplemental content item is received based at least in part on:
the MoQ relay device receiving a plurality of offers from a plurality of supplemental content providers to select their supplemental content, wherein the supplemental content item received at the MoQ relay device corresponds to a supplemental content provider whose offer was accepted.

7. The method of claim 1, wherein the request to the supplemental content server to provide the supplemental content is a first request, the method further comprising:
determining, at the MoQ relay device, that an initial object of a second group of the plurality of groups corresponds to an additional supplemental content insertion point;
transmitting, by the MoQ relay device, a second request to the supplemental content server to provide supplemental content via the bi-directional connection between the MoQ relay device and the supplemental content server;
receiving, at the MoQ relay device, an indication that no suitable supplemental content item was identified by the supplemental content server; and
transmitting the second group of the plurality of groups to the client device.

8. The method of claim 1, wherein the MoQ relay device is at least one of:
a node of a content delivery network, a mesh network node, an IoT gateway, or a cloud-based relay.

9. The method of claim 1, wherein the MoQ relay device is a first MoQ relay device, and wherein the client device is a first client device, the method further comprising:
establishing, by the first MoQ relay device, a bi-directional connection between the first MoQ relay device and a second MoQ relay device, wherein the second MoQ relay device is configured to make bi-directional connections with a second client device.

10. The method of claim 9, further comprising:
receiving, by the first MoQ relay device, a request to subscribe to the media stream from the second client device via the bi-directional connection between the MoQ relay device and the second MoQ relay device.

11. The method of claim 1, wherein the each object of the plurality of objects corresponds to at least one of a video frame or a GOP.

12. A system comprising:
control circuitry configured to:
establish, by a Media-over-QUIC (MoQ) relay device, a bi-directional connection between the MoQ relay device and a client device;
input/output circuitry configured to:
receive, from the client device, a request to subscribe to a media stream;
wherein the control circuitry is further configured to:
based at least in part on receiving, from the client device, a request to subscribe to the media stream, establish, by the MoQ relay device, a bi-directional connection between the MoQ relay device and a publisher of the media stream;
receive, at the MoQ relay device, the media stream from the publisher to be transmitted to the client device via the bi-directional connection between the MoQ relay device and the client device, wherein the media stream comprises a plurality of groups, wherein each group comprises a respective plurality of objects;
determine, at the MoQ relay device, that an initial object of a particular group of the plurality of groups corresponds to a supplemental content insertion point;
transmit, by the MoQ relay device, a request to a supplemental content server to provide supplemental content via a bi-directional connection between the MoQ relay device and the supplemental content server;
receive, at the MoQ relay device, the supplemental content item via the bi-directional connection between the MoQ relay device and the supplemental content server;
prevent, at the MoQ relay device, transmission of at least the particular group of the plurality of groups to the client device via the bi-directional connection between the MoQ relay device and the client device; and
transmit the supplemental content item in place of at least the particular group of the plurality of groups to the client device via the bi-directional connection between the MoQ relay device and the client device.

13. The system of claim 12, wherein the client device is one of a plurality of client devices, and wherein the MoQ relay device establishes a bi-directional connection between the MoQ relay device and each of the plurality of client devices, wherein the control circuitry is further configured to:
transmit, by the MoQ relay device, the media stream and the supplemental content item to each of the plurality of client devices.

14. The system of claim 13, wherein the request to the supplemental content server to provide the supplemental content comprises at least one of:
preference information corresponding to the plurality of client devices, metadata related to the media stream, or a length of the supplemental content insertion point.

15. The system of claim 12, wherein the control circuitry is further configured to:
receive a data structure identifying the supplemental content item, wherein the supplemental content item is received based on transmitting a request, by the MoQ relay device, using information from the data structure.

16. The system of claim 15, wherein the data structure identifying the supplemental content item is received based at least in part on:
the supplemental content server receiving a plurality of offers from a plurality of supplemental content providers to select their supplemental content, wherein the supplemental content item received at the MoQ relay device corresponds to a supplemental content provider whose offer was accepted.

17. The system of claim 15, wherein the data structure identifying the supplemental content item is received based at least in part on:
the MoQ relay device receiving a plurality of offers from a plurality of supplemental content providers to select their supplemental content, wherein the supplemental content item received at the MoQ relay device corresponds to a supplemental content provider whose offer was accepted.

18. The system of claim 12, wherein the request to the supplemental content server to provide the supplemental content is a first request, wherein the control circuitry is further configured to:
determine, at the MoQ relay device, that an initial object of a second group of the plurality of groups corresponds to an additional supplemental content insertion point;
transmit, by the MoQ relay device, a second request to the supplemental content server to provide supplemental content via the bi-directional connection between the MoQ relay device and the supplemental content server;
receive, at the MoQ relay device, an indication that no suitable supplemental content item was identified by the supplemental content server; and
transmit the second group of the plurality of groups to the client device.

19. The system of claim 12, wherein the MoQ relay device is at least one of:
a node of a content delivery network, a mesh network node, an IoT gateway, or a cloud-based relay.

20. The system of claim 12, wherein the MoQ relay device is a first MoQ relay device, and wherein the client device is a first client device, wherein the control circuitry is further configured to:
establish, by the first MoQ relay device, a bi-directional connection between the first MoQ relay device and a second MoQ relay device, wherein the second MoQ relay device is configured to make bi-directional connections with a second client device.

21-55. (canceled)
